(19) United States
(12) Patent Application Publication
(10) Pub. No.: US 2005/0038314 A1
(43) Pub. Date: Feb. 17, 2005

(54) Infrared communication with infant care apparatus

(76) Inventor: Steven M. Falk, Baltimore, MD (US)

Correspondence Address: ROGER M. RATHBUN, 13 MARGARITA COURT, HILTON HEAD ISLAND, SC, 29926, US

(21) Appl. No.: 10/640,392

(22) Filed: Aug. 13, 2003

(51) Int. Cl. A61G 11/00

(52) U.S. Cl. 600/22; 128/903

(57) ABSTRACT

An infant care apparatus for providing heat to an infant. The infant care apparatus has an internal electronic communication module that allows it to send and receive information to and from the infant care apparatus for use by that infant care apparatus. A personal digital assistant (PDA) is provided that can communicate with the internal electronic communication module such that information can be exchanged between the internal electronic module and the PDA to allow a user to download information from the internal communication module to the PDA and to use to PDA to enter information into the internal electronic communication module to be used in the infant care apparatus.

### BACKGROUND

The present invention relates to an infant care apparatus and, more particularly, to an apparatus for providing certain physiological support to an infant with a wireless communication system to allow the transfer of information to and from that infant apparatus with the use of a personal digital assistant.

There are, of course, many devices or apparatus for the warming of an infant, that is, to supply the necessary heat to maintain the infant at a predetermined temperature. Typical of such apparatus is shown and described in U.S. Pat. No. 6,231,499 of Jones entitled LIFT MECHANISM FOR INFANT CARE APPARATUS CANOPY and U.S. Pat. No. 6,585,636 of Jones et al entitled HEATER DOOR MECHANISM FOR INFANT WARMING APPARATUS.

One of the difficulties, however with such apparatus is in the need to communicate with the internal electronic circuitry of the infant care apparatus for a variety of reasons during its operation. As examples of information to be communicated to and/or from the electronic circuitry of the infant care apparatus, there is often a need to carry out the upgrade of software that is being utilized in the operation of the infant care apparatus as newer software revisions are developed. At the present, therefore, it is normally necessary that software upgrades be carried out by a technician entering the electronic controller of the infant care apparatus in order to replace an existing programmable read only memory (PROM) with a PROM having the upgraded software.

Other types of information that would be desirable to be readily communicated to and from an infant care apparatus, include the entry of patient information into the infant care apparatus, such as patient name, weight and other vital information personal information of the patient and which would be preferably be continually updated as new information is obtained or the condition of the infant changes.

Also, it would be desirable to be able to readily download information from the infant care apparatus concerning its operation such as diagnostic information including voltages, service history of a particular apparatus, failures, calibration dates and the like so that a running and current record can be maintained concerning the operation of the infant care apparatus to be used by a technician to diagnose or monitor its operation.

In addition, it is often valuable to be able to download trends relating to the performance of the infant care apparatus, such as thermal or humidity information to maintain a trend of the data and to enter the data in the form of a commercial program, such as Excel, to create a recognizable and convenient format for that information so as to maintain that information and data without the need for additional hardware.

Accordingly, in any case, the ability to provide a continuous bidirectional exchange of information with an infant care apparatus is a valuable function for such apparatus, and it would, therefore, be advantageous to be able to carry out that communication without the use of hardwiring, an input port or the need to take the apparatus out of service to replace a component within the electronic circuitry by a electronic technician.

As can be recognized, the continuous updating of patient personal information may need to be done on a relatively frequent basis. It is convenient to carry out the inputting of that data and information by some manual means located on the apparatus itself and it is also important that the frequent updating of personal information and updating of software revisions or the downloading of information such as trending data or diagnostic information be rapid, relatively easy and be carried out by persons relatively unskilled in electronic circuitry.

There have been wireless systems disclosed in the medical field for the transfer of physiological information of a patient to a central station, and one such system is shown and described in U.S. Pat. No. 5,417,222 of Dempsey et al where a telemetry system interfaces a patient monitor to collect patient physiological information and to transmit that information and data in a bidirectional manner to and from a central station, however, the transfer of patient monitored data and the use of that system is to maintain a continuous monitor of certain measured physiological information of the patient in order to monitor that patient. Similar wireless or telemetric monitors have also been used to carry out a continuous monitor of a patient's cardiac condition and the like where the patient is constantly monitored to maintain information relating to the heart condition and that information transferred by some wireless means to a central monitor where the patient's condition can be recorded and continually ascertained.

It would, however, be advantageous to have a bidirectional communication system where the system is not used in the monitoring of a physiological condition of a patient and sent to a central location to track the conditions of patient but instead have a wireless communication system that provides for bidirectional communication between a personal digital assistant and a patient care apparatus, in order to send and receive data and information to the patient care apparatus for a variety of purposes.

### SUMMARY OF THE INVENTION

Accordingly, the present invention relates to an infant care apparatus that has a built-in two way communication system that enables a person to input information to the various electronic circuitry and memory devices of the infant care apparatus and also to download information from that electronic circuitry within the infant care apparatus conveniently, easily and without the need for an electronic technician, by the use of an infrared wireless communication device such as a personal digital assistant (PDA), commonly available as a Palm Pilot or similar type of device.

The PDA used with the present invention can be of a conventional type having an entry device in the form of a keyboard, a display to allow the user to see data and information received from the infant care apparatus and a transmitter/receiver to send and receive that information and data. The infant care apparatus also has an electronic module having a transmitter/receiver that enables it to communicate by a conventional protocol, such as infrared, with the PDA such the information can be sent in both directions, that is, to and from the infant care apparatus and the PDA.

The infant care apparatus has it normal, commercial electronic control circuitry including a CPU and various electronic memory and storage devices, in the form of read only memory devices, preferable PROMS, that enable the infant care apparatus electronic circuitry to utilize the electronic module to receive, transmit and store information with respect to the PDA and enable the infant care apparatus to use the information for the intended purpose, be it to store the information, display the information or use the information in the operation of the infant care apparatus.

The infant care apparatus also has its commercial operational software that is used to carry out its operation and which can also be accessed by the communication system of the present invention between the infant care apparatus and the PDA so that the PDA can send upgraded software and software revisions to the operational software that is being used in the infant care apparatus to carry out the upgrade of that existing software then in use in the infant care apparatus.

As normal components of the infant care apparatus, there are certain data memory and storage devices as well as data sensing capabilities to extract and store operational data relative to the operation of the infant care apparatus, such as voltages, service history of the apparatus, as well as to provide service diagnostic information that can be downloaded by means of the electronic module from the infant care apparatus circuitry and storage devices to the PDA as well as maintain trend information, such as thermal or humidity trends that can be downloaded to the PDA when desired.

Any of the information downloaded to the PDA can, therefore, be visually perceived on the PDA display or be available for further transfer to a computer by means of a data outlet on the PDA to process that information and develop that data into a particular desired form at the option of the user.

These and other features and advantages of the present invention will become more readily apparent during the following detailed description taken in conjunction with the drawings herein.

### BRIEF DESCRIPTION OF THE DRAWINGS

FIG. 1 is a perspective view of the overall two way infrared communication system of the present invention showing the infant care apparatus and a hand held personal digital assistant (PDA); and

FIG. 2 is a block schematic diagram of the various components used in carrying out the present invention.

### DETAILED DESCRIPTION OF THE INVENTION

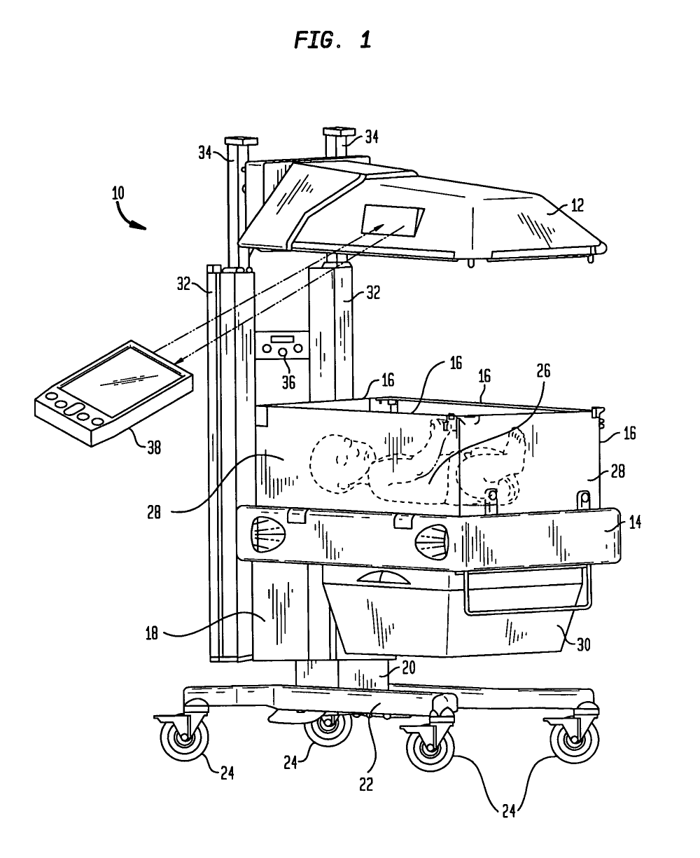

Referring now to FIG. 1, there is shown a perspective view illustrating the present invention and showing an infant care apparatus 10 constructed in accordance with the present invention. Although the invention is shown and described specifically in relation to an infant care apparatus, it will be seen that the present invention can be applicable to other types of patient care apparatus, including other types of infant care apparatus, and still carry out the purposes of the present invention.

In FIG., 1, therefore, the infant care apparatus 10 includes a canopy 12 shown in its upper position. The infant care apparatus 10 is but one example of an infant care apparatus, such as an incubator or infant warmer, and will be described herein as an apparatus that can function both as an incubator when the canopy 12 is in a lower position and an infant warmer when the canopy 12 is in its upper position as shown in FIG. 1.

The apparatus itself can be of the type that is shown and described in U.S. Pat. No. 6,231,499 of Jones entitled LIFT MECHANISM FOR INFANT CARE APPARATUS CANOPY and U.S. Pat. No. 6,585,636 of Jones et al and entitled HEATER DOOR MECHANISM FOR INFANT WARMING APPARATUS, and the disclosures of those U.S. patents are hereby incorporated herein by reference in their entirety.

As shown, the infant care apparatus 10 includes an infant pedestal 14 that underlies and supports an infant. As is also seen, a plurality of walls 16 are provided to contain the infant safely within the infant care apparatus 10 and are located at all of the four sides of the infant pedestal 14. The walls 16 are preferable constructed of transparent plastic material and cooperate with other components in order to provide an incubator function to the infant care apparatus 10 when the infant care apparatus 10 is functioning as an incubator.

The infant pedestal 14 is mounted to a moveable vertical base member 18 which, in the preferred embodiment, is movably affixed to a stationary vertical base member 20, which, in turn, is mounted to a base 22 having wheels 24 for ready movement of the infant care apparatus 10.

The vertical movable base member 18 is preferably mounted so that the user can adjust the height of the infant pedestal 14 by raising and lowering the movable vertical member 18 as desired, thus the infant pedestal 14 can be adjusted to the preferred height by the user. As further standard features, the walls may have handholes (not shown) to afford access to the infant 26 when in the incubator configuration and which generally have doors 28 that can be opened to obtain access to the infant 26 and, of course, closed when the particular intervention has been completed to preserve the desired environment surrounding the infant.

Another convenient feature includes a drawer 30 to retain supplies or other devices needed to carry out some operation on the infant and which is normally located beneath the infant pedestal 14. Other features include the maneuverability of the walls 16 that are pivotally mounted at their bases to the infant pedestal 14 such that the doors can be swung outwardly and downwardly and, as a further alternative, can be easily fully removed from the infant pedestal 14. As such, therefore, when the canopy 12 of the infant warming apparatus 10 is in its upper position as shown in FIG. 1, the walls 16 can be dropped downwardly or removed altogether so that the attending personnel can have unlimited access to an infant resting on the infant pedestal 14 to perform interventions on that infant.

Further structural components of the infant warming apparatus 10 include stationary frame members 32 that are affixed to the base member 18 and, as shown, there are two vertical stationary frame members 32 in the preferred embodiment although there may be only one or there may be further numbers of such members. Two vertical movable frame members 34 are movably fitted into the stationary frame members 32 and which can be moved upwardly and downwardly by the user in converting the infant care apparatus 10 between its function as an incubator and its function as an infant warmer.

A control module 36 is conveniently positioned intermediate the stationary frame members 32 and may include displays of various monitored parameters as well as include the various controls for operation of the functions of the infant warming apparatus 10.

As may now be seen in general, in the operation of the infant warming apparatus 10, the canopy 12, in the preferred embodiment, houses a radiant heater (not shown). The canopy 12 can be moved between its upper position, as shown in FIG. 1, wherein the infant care apparatus acts as an infant warmer and a lower position wherein the infant care apparatus acts as an infant incubator where the infant 26 is provided with warm air and controlled humidity in the normal functioning of an incubator.

As also can be seen in FIG. 1, there is a personal digital assistant (PDA) 38 that is used in connection with the present invention. The PDA 38 can be of the conventional and commercially available type such as a Palm Pilot, and which includes a display 40, an input device such as a keyboard 42 and which also has an internal central processing unit (CPU) and a transducer to carry out the transmitting and receiving of data as will be later explained. The PDA 38 generally communicates and receives electronic signals bi-directionally using an infrared (IrDA) communications protocol. There is also, preferably, an input/output or I/O port 44 that enables the PDA 38 to upload data and information to a computer such as a laptop or portable computer and also have information and data downloaded from a computer to the PDA 38.

As noted, the form of communication used by the PDA 38 is preferably an infrared protocol, however, other suitable forms of radiation transmission can be used, including RF elements or other means.

There is a corresponding electronic module 46 that is located in the infant care apparatus 10 in a position so as to readily receive and send communications between the electronic module 46 and the PDA 38. The electronic module 46 can thus internally transfer data and information to and from various internal components of the infant care apparatus 10, such as internal software, read only memory, and to the operating processor or processors that carry out the operation of the infant care apparatus 10.

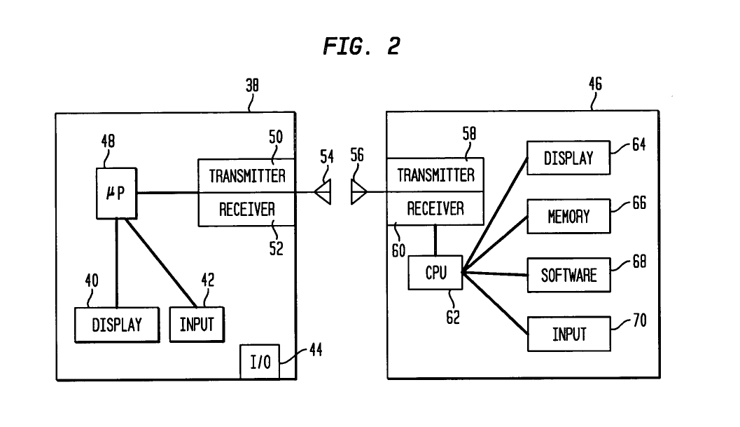

Turning now to FIG. 2, there is shown a block schematic diagram of the components utilized in carrying out the present invention. In particular, the PDA 38 can be seen to have an input device, such as a keyboard 42, a display 40 as well as a microprocessor 48 contained therein. The PDA 38 also includes a transmitter 50, a receiver 52 and an antenna 54 to enable the bi-directional communications with the PDA 38.

In the electronic module 46 there are also various components to carry out the bi-directional communications and which include an antenna 56 that carries the signals to and from a transmitter 58 and a receiver 60 in effecting those communications.

Additionally, as can be seen, there is also a central processing unit 62 in the electronic module 46 and which is in communication with a display 64, an internal memory 66, the operational software 68 of the infant care apparatus 10 and an input device 70. The display 64, internal memory 66, operational software 68 and input device 70 normally will be a part of the infant care apparatus 10 and therefore positioned at one or more locations thereon, including within the control module 36.

As such, the operation of and functioning of the present invention can be explained. As a function of the present invention, it is normal that the operational software used in the control and operation of the infant care apparatus 10 needs to be upgraded from time to time and the present upgrading procedures require the removal of programmable read only memory units (PROMS) and the installation of new PROMS having the upgraded software and that procedure requires the services of a qualified technician and also involves downtime for the infant care apparatus and thus, the removal of the apparatus from active service while that replacement is being carried out.

With the present invention, however, the upgraded software can simply be downloaded into the PDA 38 via the I/O port 44 from a computer and the PDA 38 put in wireless communication with the electronic module 46 located on the infant care apparatus 10. That upgraded software can, therefore, be transmitted by means of the transmitter 50 of the PDA 38 to the receiver 60 of the electronic module 46 and the CPU 62 can enter that upgraded software into the operational software 68 of the infant care apparatus 10 such that there is no invasion of the electronic module 46 or physical replacement of an PROM thereby resulting in little or no downtime for the apparatus and the procedure can be carried out easily with a person having basic computer qualifications.

As another function of the present invention, the electronic module 46, can, by means of the internal memory 66, maintain a continual log of the operational data of the infant care apparatus 10, that is, there may be continually kept, a data log of the electrical and functional status, such as recorded voltages, service history of a particular apparatus, data relating to failures, calibration dates and the like and which relate to the operational history of the infant care apparatus 10 and that information can be, by a query from the PDA 38, sought by the CPU 62 and sent by the transmitter 58 of the electronic module 46 to the receiver 52 of the PDA 38 where that service and history information and data can be, again, uploaded to a personal computer where the data can be used with commercial software, such as Excel, to create a table of information and data or to formulate curves indicative of the performance of the particular infant care apparatus 10 in a form that is readily understandable.

As a still further function of the present invention, patient information can be inputted by the input device 70 located at or on the infant care apparatus 10 such as name, weight, and other personal information by the caregiver from time to time to upgrade the status of the patient or to enter other such information and, again, that personal information and data relating to the patient can be sent to the PDA 38 from the electronic module 46 so that such information can be entered by the personal computer to a central record keeping file for patients undergoing treatment at the facility.

As a still further function, there can be a continuous maintaining of operational data in the internal memory 66 of the electronic module 46, such as trending information including thermal or humidity information to maintain a trend of the data and that information can be transmitted to the PDA 38 for uploading to a personal computer when the trending data can also be organized into a recognized format by an Excel or other commercial software program.

Thus, as can be seen, with the present invention there is a bidirectional communication between the PDA 38 and the infant care apparatus 10 that enables the easy, wireless transfer of data and information therebetween, such that a number of advantageous functions and operations can be carried out without taking the apparatus out of service.

Those skilled in the art will readily recognize numerous adaptations and modifications which can be made to the bidirectional wireless data and information communication system for a patient care apparatus of the present invention which will result in an improved system, yet all of which will fall within the scope and spirit of the present invention as defined in the following claims. Accordingly, the invention is to be limited only by the following claims and their equivalents.

1. A patient care apparatus, said patient care apparatus comprising a base having a support on which a patient is positioned to carry out some medical treatment or physiological aid to a patient, an electronic communication module contained within the patient care apparatus adapted to send and receive information to and from the patient care apparatus and a personal digital assistant device for communicating with the electronic communication module within the patient care apparatus to transmit and receive information to and from the electronic communication module.

2. The patient care apparatus as defined in claim 1 wherein said patient care apparatus is an infant care apparatus for providing a heated environment to an infant.

3. The patient care apparatus as defined in claim 1 wherein the patient care apparatus is operated by operational software and said personal digital assistant device communicates upgraded software to the electronic communication module in the patient care apparatus to upgrade the operational software by providing revisions thereto.

4. The patient care apparatus as defined in claim 1 wherein the patient care apparatus has a memory device adapted to receive and store operational and performance information concerning the patient care apparatus and the operation and performance information is adapted to be downloaded by the electronic communication module to the personal digital assistant device.

5. The patient care apparatus as defined in claim 1 wherein the patient care apparatus includes an input device wherein personal patient information can be inputted to the electronic communication module to be transmitted to the personal digital assistant device.

6. The patient care apparatus as defined in claim 1 wherein the person digital assistant device has an input/output port for communication between the personal digital assistant device and a personal computer.

7. The patient care apparatus as defined in claim 1 wherein the patient care apparatus has a internal memory device to obtain and store trending information relating to the performance of the patient care apparatus and wherein the electronic communications module is adapted to transmit that trending information to said personal digital assistant device.

8. The patient care apparatus as defined in claim 7 wherein the person digital assistant device has an input/output port for communication between the personal digital assistant device and a personal computer and where the personal digital assistant device is adapted to transmit the trending information to said personal computer for conversion to a convenient display of trending data.

9. A method of providing wireless communication between a personal digital assistant and a patient care apparatus, the method comprising the steps of:
providing a patient care apparatus for use in carrying out the treatment of a patient and having an electronic communication module contained within the patient care apparatus adapted to send and receive information to and from the patient care apparatus,
providing a personal digital assistant for communicating with the electronic communication module within the patient care apparatus to transmit and receive information to and from the electronic communication module,
using the personal digital assistant to communicate information to and receive information from the electronic communication module.

10. The method of providing a wireless communication as defined in claim 9 where the step of providing a patient care apparatus comprises providing an infant care apparatus.

11. The method as defined in claim 9 wherein the step of providing a patient care apparatus comprises providing a patient care apparatus controlled by operational software and wherein the step of using the personal digital assistant comprises communicating information from the personal digital assistant to the electronic communication module comprises communicating software upgrades and revising the operational software to use the upgraded software to control the operation of the patient care apparatus.

12. The method as defined in claim 9 wherein the step of providing a patient care apparatus comprises providing a patient care apparatus having an internal memory for storing operational and performance information relating to the patient care apparatus and wherein the step of using the personal digital assistant comprises communicating information from the electronic communications module to the personal digital asistant relating to the operational and performance information of the patient care apparatus.

13. The method as defined in claim 9 wherein the step of providing a patient care apparatus comprises providing a patient care apparatus having an internal memory adapted to receive and store information relating to trending information of the operation of the patient care apparatus and wherein the step of using the personal digital assistant comprises communicating information from the electronics communication module to the personal digital assistant relating to trending information of the patient care apparatus.

14. The method as defined in claim 9 wherein the step of providing a patient care apparatus comprises providing a patient care apparatus having an internal memory and an input device to input personal information relating to a patient to the internal memory and wherein the step of using the personal digital assistant comprises communicating information from the hand-held device to the electronic communication module comprises communicating information from the electronics communication module to the personal digital assistant relating to personal information of a patient undergoing treatment by the infant care apparatus.

15. A communication system for an infant care apparatus, said communication system comprising a electronic module affixed to the infant care apparatus, said electronic module having a receiver, a transmitter and a microprocessor, a personal digital assistant having a transmitter, a receiver and an input device, said electronic module and said personal digital assistant adapted to bi-directionally transmit and send infrared signals therebetween.

16. The communication system as defined in claim 15 wherein said personal digital assistant includes an input/outlet port for downloading and uploading electronic data to and from a personal computer.

17. The communication system as defined in claim 15 wherein said personal digital assistant includes an input device to input electronic information into the personal digital assistant for transmitting the electronic information to said electronic module.

18. The communication system as defined in claim 15 wherein said electronic module is adapted to receive information stored in the infant care apparatus and to transmit that information to said personal digital assistant.
